(19) United States
(12) Patent Application Publication
(10) Pub. No.: US 2010/0096341 A1
(43) Pub. Date: Apr. 22, 2010

(54) Pressure filter apparatus and method using interstitial expanding gas

(75) Inventor: Steve C. Benesi, Novato, CA (US)

Correspondence Address: Daniel DeJoseph;FLSmidth Inc., 2040 Avenue "C", Bethlehem, PA, 18017, US

(73) Assignee: FLSmidth A/S

(21) Appl. No.: 12/288,207

(22) Filed: Oct. 17, 2008

(51) Int. Cl. B01D 25/127; B01D 25/32

(52) U.S. Cl. 210/771; 210/105; 210/209; 210/141

(57) ABSTRACT

A method and apparatus is disclosed for separating a slurry into liquids and solids in a pressure filter apparatus and for forming a substantially dry and often loosely packet filter solids cake wherein a high temperature and high pressure steam is introduced into an initially formed filter cake in the pressurized filter apparatus to force the steam into the interstices of the formed filter cake and then pressure within the filter apparatus is reduced to permit the steam to flash and to expand within the interstices to absorb any remaining fluids within the formed filter cake and to cause the filter cake to become substantially dry and loosely packed. The filtered solids cake is then discharged from the filter apparatus.

### CROSS REFERENCE TO RELATED APPLICATIONS

None

### BACKGROUND OF THE INVENTION

1. Field of the Invention

This invention relates to slurry filtration apparatus, and systems and methods for operating such apparatus for separating slurry into slurry liquid and slurry solids and for forming a substantially dry and loosely packed filtered slurry solids cake from said slurry. More particularly the apparatus, systems for operating, and methods provide for producing a filtered slurry solids cake that has low remaining liquid and is preferably fractured and friable as distinguished from a moist substantially solid cake by penetrating the interstices of a filter cake and expanding a fluid within the interstices.

Slurries of solids and liquids produced in many processes require separation of the liquids and solids to produce a desired product or products; the product may be either the solid or the liquid or both the liquid and the solid part of the slurry. Such processes include, for example manufacturing, mining, energy generation, pharmaceutical products and food ingredients to name a few. Sought-after efficiencies in accomplishing the separation include: (1) the quality of the separated liquid or solid (e.g. the dryness of the solid or the percentage solids, or liquids obtained; (2) minimizing the amount (quantity of pieces, cost and/or bulk) of equipment used to accomplish the separation; (3) minimizing and/or optimizing the space required to accomplish the separation (in terms of equipment “footprint” or square or cubic footage occupied by the equipment and associate plumbing; (4) minimizing the amount of energy used to accomplish the separation; (5) minimizing the time used accomplish the separation; (6) maximizing the production of solids and filtered liquid per unit of filter area; (7) minimizing the amount of treatment or washing fluids required to achieve the desired separation; (8) minimizing waste of process streams and/or (9) producing a filtered slurry solids cake that is especially useful to the next step in a processing operation. In other words, efficiency in the separation system is thus dependent upon the time and energy taken to accomplish the separation as well as the amount of utilities and space needed for the system and the need for multiple pieces of equipment to accomplish the separation and quality of separated product. The present invention is directed to a system and apparatus for efficiently separating liquids from solids in a slurry stream with a minimum of equipment and energy, and with the use of a limited amount of space and utilities while producing the desired end result of a liquid and/or solid and often friable product.

2. Description of the Prior Art

Prior art separating systems have used centrifugal mechanisms for separating liquids and solids followed by rotary, flash, fluid bed, or belt dryers for producing a product. Others have used diaphragm membrane filters that press liquids for solids followed by drying processes to dry the solids separated thereby. Other filters systems employ a pressure filter which comprises a filter chamber into which a slurry is distributed, and subsequent to the introduction of the slurry, one or more liquids or fluids (including gases) is introduced into the chamber to assist in forcing the separation of the liquids from the solids in the chamber resulting in a filter cake of desired physical characteristics.

### SUMMARY OF THE INVENTION

In one embodiment, the present invention includes an apparatus and process which may use all or part of the filter apparatus disclosed in U.S. Pat. Nos. 5,059,318; 5,292,434; 5,462,677; 5,477,891; 5,510,025; 5,573,667; 5,615,713; 6,159,359; 6,491,817 and 6,521,135; U.S. Published Patent Application 20030127401; and 2005030258, all by the present inventor, all of which are incorporated by reference herein. In addition, some embodiments of the present invention include elements for conditioning the slurry or components thereof prior to entry into the filter apparatus, and/or within the filter apparatus itself, and the control of gas, fluid and liquid introduced into the filter apparatus to produce a product of desired quality.

In addition to the several embodiments of the filter apparatus shown and described in the foregoing patents, the apparatus and process of the present invention further includes conditioning elements of the filter apparatus itself (e.g. the filter medium, or filter plates, or other structural elements), prior to or concurrently with conditioning the slurry itself. The apparatus and process may include a controller or controllers to control operation of the peripheral equipment, to control the introduction of slurry into the filter apparatus, to control the introduction of conditioning or conditioned air, gasses, steam, heat or pressure, into the slurry and/or into the filter apparatus, and to control additional peripheral equipment for processing and/or treatment of the slurry within the chamber, or treatment of the apparatus itself, for the production of both desired liquids and solids from the filter apparatus.

In another embodiment of the prior art illustrated in the above patents, methods and apparatus are disclosed for separating solids and liquids from a slurry (also referred to as de-watering) which results in improved drying of the solids with (1) lowest energy use; and/or (2) use of a minimum amount of apparatus; and/or(3) use of a minimum amount of space for the apparatus; and/or (4) least amount of time necessary to accomplish the separation; and/or (5) minimizing the amount of treatment or washing fluids required to achieve the desired separation; and/or (6) minimizing waste of process streams. The present invention also contemplates any combinations of the foregoing. The foregoing can be accomplished in a variety of ways as set forth in the various embodiments of the present invention disclosed herein.

An object of the present invention is a further improvement of the prior art processes to produce a filtered slurry solids cake of low moisture content that is particularly desirable in the next procedure in a manufacturing process.

A further object in accord with the foregoing object is an apparatus and method for producing a filter cake that is loosely packed, fractured and friable for further uses.

Further objects and features of the present invention will be readily apparent to those skilled in the art in view of the appended drawings and specification illustrating preferred embodiments wherein:

### BRIEF DESCRIPTION OF THE DRAWINGS

FIG. 1 is a schematic block diagram illustrating operational steps of one embodiment of a method of the present invention;

FIG. 2 is a schematic presentation of a filter apparatus and peripheral apparatus used to perform the methods of the present invention;

FIG. 3 is a perspective view of an embodiment of a filter apparatus of the present invention;

FIG. 4 is a photograph of a filter solids cake produced with the apparatus shown in FIG. 3 and using a series of steps without the expanding gas process of the present invention.

FIG. 5 is a photograph of a filter solids cake produced with the apparatus of FIG. 3 and the same slurry input but using the expanding gas process of the present invention.

FIG. 6 is a chart showing the sequence of steps of the method of the present invention.

### DETAILED DESCRIPTION OF THE PRESENT INVENTION

Definitions:

Before describing the present invention in detail, it is to be understood that the invention is not limited to the particularly exemplified apparatus, systems, method, or process disclosed herein, which may, of course vary. It is also to be understood that the terminology used herein is for the purpose of describing particular embodiments of the invention only, and is not intended to limit the scope of the invention in any manner.

All publications, patents and patent applications cited herein, whether supra or infra, are hereby incorporated by reference in their entirety to the same extent as if each individual publication, patent or patent application was specifically and individually indicated to be incorporated by reference.

It is to be noted that, as used in this specification and the appended claims, the singular forms “a”, “an”, and “the” include the plural unless the content clearly dictates otherwise. Thus, for example, reference to a “controller” includes one, two or more such controllers.

Unless defined otherwise, all technical and scientific terms used herein have the same meaning as commonly understood by one of ordinary skill in the art to which the invention pertains. Although a number of methods and materials similar or equivalent to those described herein can be used in the practice of the present invention, the preferred materials and methods are described herein.

As used herein, unless otherwise clear from the context, the term “slurry” includes a mixture of liquids and solids which is input into the separation apparatus, and also includes fully or partially separated solids and liquids.

The term “psi” refers to absolute pressure.

“Maximal” drying contemplates that essentially all desired liquid has been separated from the solids, given the end or desired use to which the solids and/or liquids is put.

“Optimal” drying contemplates that a desired or target level of liquid has been separated from the solids, given the end or desired use to which the solids and/or liquids is put.

“Fractured”, “loosely packed”, “friable”, and “often” as referred to these terms and similar terms refer to filter cake that is desirable for further process uses as distinguished from a substantially solid compact filter cake.

“Elevated” referring to temperature means greater than ambient as compared to the substrate, component or surface to which the temperature refers; and “elevated” referring to a pressure means greater than atmospheric pressure.

“Fluid” is used to mean both a liquid, or a gas, or a combination thereof, unless otherwise clear from the context that the fluid is limited to a liquid or to a gas.

Slurry means a flowable mixture of solids and liquids, the solids generally insoluble in the liquids at conventional temperatures and pressures. The slurry is further defined as the material which is to be separated into a liquid stream and a solid stream, the latter also known as the filter “cake.”

Poiseuille's Law states that the velocity of a liquid flowing through a capillary is directly proportional to the pressure of the liquid and the fourth power of the radius of the capillary, and is inversely proportional to the viscosity of the liquid and the length of the capillary.

It is to be understood that unless otherwise clear from the context, any feature, element, sub-process, condition or parameter described in connection with a particular embodiment of the system, apparatus, process or method is applicable to each and every embodiment of the system, apparatus, process or method described herein.

Generally, the apparatus of the present invention comprises: (i) a filtration chamber, which is sealable to confine a slurry such that a pressure differential can be applied thereto, (ii) a filter medium within the filtration chamber, (iii) slurry inlet means, (iv) liquid discharge means, (v) solids discharge means, (vi) treatment fluid input means, (vii) a steam generator, (viii) system monitoring and controlling means.

The process of the present invention generally comprises the steps of: (i) closing and sealing a filtration chamber, (ii) filtration chamber heating, (iii) slurry fill, (iv) application of a pressure differential to the slurry within the filtration chamber to initiate the formation of a filter cake, (v) optionally, application to the filter cake within the chamber of non-condensing gas as a clearing fluid, (vi) application of steam to the filter cake to penetrate the pores of the filter cake and pressurize the filtration chamber, (vii) releasing the pressure within the filtration chamber to permit the steam to flash and expand within the filter cake, (viii) optionally, application of air or gas to force liquids from the filter cake, and (x) discharging the dried filter cake.

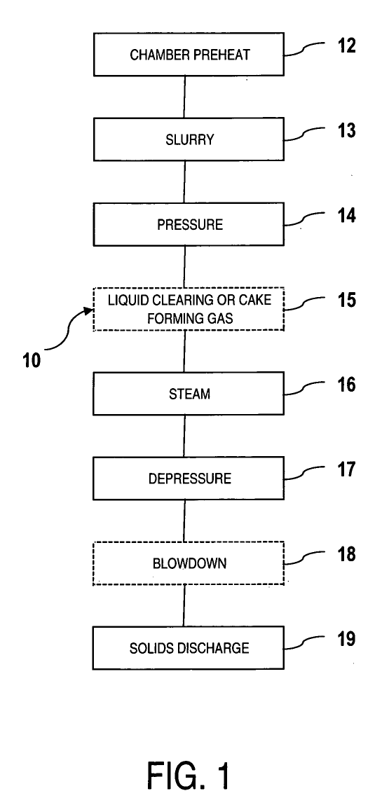

FIG. 1 illustrates an overall separation system 10 of the present invention, in terms of process steps, in a schematic block diagram form. The process steps of FIG. 1 which are illustrated in dashed line blocks are optional steps, as described more fully herein. The first block 12 comprises a filtration chamber preheat step. A slurry fill step, shown as block 13, commences the separation process. Following the slurry fill step 13, there may be an application of pressure differential as shown in block 14. The applied pressure differential can comprise a pressure supplied by filling the chamber with slurry, or can comprise an applied fluid, e.g. a gas, introduced into the chamber, or can comprise a mechanical expression, or any combination thereof. “Mechanical expression” as used herein, comprises a squeezing, such as by a flexible or elastomeric component, for example a diaphragm or bladder. Optional block 15, comprises the step of applying a cake-forming or clearing gas or fluid. Block 16 comprises the step of introducing a high temperature and high pressure steam. Block 17 comprises the step of depressurizing the filtration chamber after the applied steam has penetrated the interstices of the formed filter cake. Optional block 18, comprises the step of applying a gas or fluid for extracting liquids that have become released from the interstices of the formed filter cake. Block 19 is the step of discharging the filter cake from the filtration chamber.

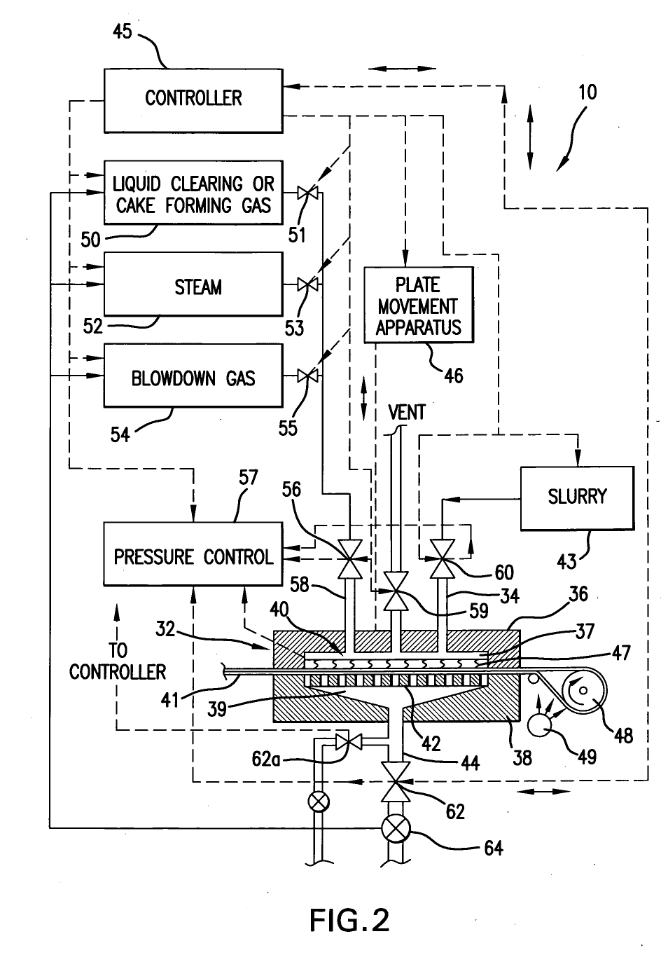

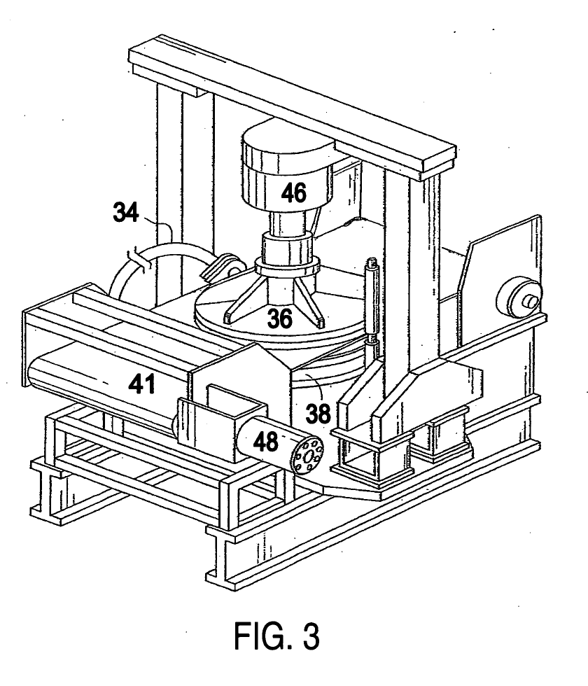

FIG. 2 illustrates the overall separation system 10 in schematic block diagram, and with further references to apparatus. The system 10 may include a filter apparatus and the peripheral apparatus used to perform the method of the system. All or selected parts of the peripheral apparatus may be used as described herein with reference to the various embodiments of the present invention. FIGS. 1 and 2 illustrate one embodiment of the present invention wherein a pressure filter-type apparatus and corresponding pressure filtration protocol is used to effect the separation of liquids and solids from a slurry. It should be noted, however, that the apparatus and methods embodied in FIGS. 1 and 2 are illustrative only; the inventive apparatus and methods herein may be used with a variety of filtration apparatus and/or filtration methods. For example, the apparatus and methods disclosed herein may be used with hyperbaric rotary disc or drum filters; filter presses; pressure leaf filters; horizontal belt filters; diaphragm squeeze filters; centrifugal separators; automatic pressure filters (APFs); tower pressure filters; combinations of the foregoing and associated methods. FIG. 2 schematically illustrates a filter apparatus 32, and FIG. 3 is a perspective view of one embodiment of a filter apparatus 32 of the present invention. Referring to FIGS. 2 and 3, the apparatus 32 includes a slurry input valve or port 34, an upper plate 36 having an internal cavity 37, a lower plate 38 having an internal cavity 39 that together form a filter chamber 40 by mating of the plates and their internal cavities 37 and 39. The cavities 37 and 39 are preferably congruent such that the filter chamber 40 is provided between the upper and lower plates 36 and 38. The medium 41 is a porous filter belt supported on a stationary perforated plate 42 when the plates 36 and 38 are closed, and travels through the chamber 40 when the plates 36 and 38 are separated. The filter medium 41 collects slurry solids forming a slurry solids filter cake 47 of an input slurry 43 when the filter 32 is operated with the plates 36 and 39 closed, and carries a collected filter cake out of the chamber 40 (not shown) when the plates 36 and 38 are separated. The filter medium 41 can be reusable, cleanable or limited use, i.e. disposable. Liquids, separated from the slurry as filtrate, pass through the filter medium 41 and surface 42 and exit through filtrate exit port 44, which is in fluid communication with the lower cavity 39. The liquids separated from the slurry exiting via filtrate exit port 44 may be conducted to selected locations as described hereinafter.

The filter apparatus 32 may be controlled in its operations by a controller 45 which includes controls for a plate movement apparatus 46, such as equipment employed in opening and closing the plates 36 and 38, and may further control a filter media movement apparatus 48 for moving the filter medium 41 during process stages which include separating the plates 36 and 38. The controller 45 also may control the operation of input streams of several liquids or fluids, shown in FIG. 2 as liquid clearing or cake-forming gas at 50, steam at 52 and drying or conditioning gas (blowdown gas) at 54. These and other sources of fluids may be input via a valve or valves 56 to provide fluid to the filter chamber 40 through an input port 58. It should be understood that one or more of different fluids may serve as one or more of the liquid cleaning or cake forming liquid or gas, steam or drying or conditioning gas. These fluid inputs may be introduced by a single input port (not shown), or by separated input ports such as input port 58 and input port 34. When the plates 36 and 38 are closed, the slurry 43 may be introduced into the chamber 40 through a single input port 34 with suitable valve means 60, and distributed within the chamber 40.

A filtrate valve 62 and bypass valve 62a may be positioned in fluid communication with the filtrate exit port 44, and used to separate and/or direct various fluid streams exiting the port 44. For example, the filtrate valve 62 may be used to separate liquids from gases in the filtrate, or may be used to separate liquids of differing characteristics. Filtrate valve 62 and bypass valve 62a can be used to maintain pressure within the filter chamber as well as used to monitor fluids exiting from the filtration chamber during heating and some filtering processes as will be described in more detail hereinafter. As depicted in FIG. 2, a fluid stream, for example, a conditioning gas or liquid exiting port 44 with the filtrate may be directed back to its source and recycled, affording energy efficiency. A separator 64 may be positioned in fluid communication with the filtrate exit port 44, and used to separate and/or direct various fluid streams exiting the port 44. The separator 64 may be used to separate gas from liquids, or gas from gas or liquid from liquid, or combinations thereof. The separator 64 may be upstream or downstream of the valve 62, or may be in place of the valve 62.

In some embodiments of the present invention, the apparatus 32 may include a belt wash device 49. The belt wash device 49 applies a fluid, such as water or solvent to the filter medium 41 as it is moved out of the filter chamber 40 by the medium movement apparatus 48, to clean any residual slurry liquids or solids from the medium 41 in preparation for its subsequent re-introduction into the filter chamber 40 by the movement apparatus 48.

Incorporated into this description are the details of the filter apparatus construction as shown and described in prior U.S. Pat. Nos. 5,059,318, 5,292,434, 5,462,677, 5,477,891, 5,510,025, 5,573,667, 5,615,713, 6,159,359, 6,491,817, and 6,521,135; as well as co-pending applications PCT/US03/01746 (WO03/0161801), PCT/US2004/018644 (WO2005/007270), and PCT 2005030258 (WO06/031406) all of which are under common ownership with the present application; all of the disclosures of which are incorporated herein in their entirety by reference. In certain of these patents multiple filter apparatus modules with mating upper and lower plates to form the filter chambers and stacked above each other are disclosed, as well as shallow chamber filter apparatus and slurry distribution apparatus that are used in accomplishing filtration of slurry streams of variable filterability and characteristics.

An object of the system, apparatus and methods of the present invention is to treat slurries in a filter for the separation of liquids and solids, washing, leaching, and the extraction of liquid as filtrate and creating a completely or substantially or optimally dry filter cake 47 of solids. In some slurry treatment processes it is the extraction of liquid or effluent that is desired and in others it is the filter cake that is desired. The apparatus, methods and processes of the present invention for conditioning the slurry and the treatment of the slurry within the filter for formation of a cake within the filter contribute to the success of the separation operation. The physical characteristics of the filter cake 47 within the filter can depend on pretreatment operations on the slurry as well as distribution and operations within the filter.

The volume of the chamber, and, in some embodiments of the present invention its conformation, may be determined by the characteristics of the slurry being treated, and is sometimes very shallow, ½ cm to 6 cm, to provide for uniform distribution, or may be of greater vertical dimension, 15 to 22 cm, for slurries that are easily distributed. The mating of the plates forming the chamber and the sealing of the filter media preferably is at an elevated pressure so that the interior of the chamber can be subjected to pressures as high as 400 psi when applicable. The plates and the filter media can be constructed of suitable material to be able to be subjected to high temperatures and pressures as applicable during the operation of the filter apparatus. Such material for the plates can be metal, elastomers or plastics that can withstand sustained exposure to the temperatures and pressures applied to the apparatus.

After the chamber has been formed and sealed by the mating of the two plates 36 and 38 saturated steam is injected into the chamber from source 52 through valve 56 and port 58 to heat the chamber to a desired temperature. Bypass valve 62a is opened to permit monitoring the fluid exiting from the chamber 40 to monitor the temperature of the chamber by determining whether liquid or steam is exiting from the chamber 40. If the steam heating the chamber is condensing because the chamber is cooler than the steam and causing the steam to pass from a vapor state to a liquid state and to exit at bypass valve 62a as a liquid, the chamber has not been heated enough. If the fluid exiting at bypass valve 62a is a steam, the chamber has been heated to the temperature of the input steam and no change of state of the steam has occurred. This heating of the chamber with input steam may not be necessary with each cycle of the filter apparatus and can be monitored by sensing the temperature within the chamber by other suitable means. The filter apparatus of the present invention operates in batch cycles of repeated slurry input, slurry separation and discharge of a filter cake. The chamber may retain enough heat in each cycle to avoid the need of steam heating of the chamber before each cycle.

After the chamber has been heated to a desired temperature, a controlled amount of slurry is introduced into the chamber from slurry source 43 through valve 60 and port 34 and distributed throughout the chamber 40, the chamber may be (optionally) subjected to at least one controlled introduction of liquid clearing and cake forming gas 50 through its valve 51, and steam from source 52 through its valve 53 and both proceed through the valve 56 and input port 58 to initiate the formation of a filter cake 47 within the chamber on the filter medium 41. Even distribution of the slurry 43 within the chamber is typically desired to assure that any further treatment within the chamber is uniform throughout the chamber 40 and the formed cake 47. The input port 58 carries conditioning fluid, such as liquid clearing or cake forming gas from the source 50 through valve 51, or steam from the source 52 through valve 53, or drying and/or conditioning gas from the source 54 through valve 55. The timing and duration of the input of these materials is preferably under the control of the controller 45 and in accord with a suitable protocol or program, preferably implemented in software or firmware. During the input of the slurry and cake forming gases, the bypass valve 62a may be closed and the valve 62 at least partially open to provide an outlet for fluids exiting from port 44. Those fluids may include gas and liquid portions that are separated by the separator 64 to permit desired gases or liquids to be recycled to the liquid clearing or cake forming gas source 50, the steam source 52 or the blowdown gas source 54; the effluent from the slurry separated at the separator 64 is passed to a desired location or returned to the slurry (neither of these passages are shown).

Referring to FIGS. 1-3, the application of a pressure differential at block 14, following the slurry fill block 13 results in a first quantity of free liquids, the free liquids being extracted as effluent or filtrate, and the filter chamber is designed to pass those extracted free liquids through the filter media lower plate 42 to the filtrate exit port 44. The extraction of the first quantity of free liquid from the slurry forms, or begins to form, the cake 47 of solids within the chamber 40. In some embodiments of the present invention, the pressure differential applied to the slurry 43 results from pumping the slurry into the input port of the chamber. In some embodiments of the present invention, the pressure differential applied to the slurry 43 results from applying to the chamber 40 and slurry 43 a fluid under pressure, for example an inert gas, air or steam, or conditioning gas, air or steam or combination thereof. In some embodiments of the present invention, the pressure differential applied to the slurry 43 results from expression within the chamber 40 by an elastomeric diaphragm or bladder (not shown). In some embodiments of the present invention, the pressure differential applied to the slurry 43 results from combinations of slurry input pressure, fluid or gas pressure and expression.

In a further preferred embodiment of the present invention, when a substantial amount of slurry liquid has been extracted by the liquid clearing or cake forming gas, steam, and/or blowdown gas, the valve 62 and bypass valve 62a are closed or partially closed and saturated steam at elevated temperature and pressure (as shown by block 16) from source 52 is introduced into the chamber 40 through valve 56 and the chamber is subjected to the pressure and temperature of that steam. The steam penetrates through the pores of the initially formed filter cake 47 and, because the steam is superheated, can condition the cake for further liquid extraction by heating and/or by increasing cake permeability, the steam thus causes an additional amount of liquids to be forced from the initially formed cake and/or then further drying the cake 47. It is expected that the steam fluid reduces surface tension within solid/liquid interfaces within the cake interstices, and/or creates such interstices. The steam is in a vapor state and at an elevated temperature that results in the desired, maximal or optimal separation of the slurry liquids and solids. In this preferred embodiment of the system, apparatus and methods of the present invention, the is steam introduced into the chamber 40 to continue the extraction of liquid from the formed cake. Steam, especially superheated steam, can absorb and extract liquids from the cake formed within the chamber 40 and those liquids would then exit through the filtrate exit port 44. The pressure of the fluids introduced to the chamber can then be used to precipitate, and or vaporize, liquids from the cake when pressure in the chamber is reduced, and sudden changes of pressure can be used to create desirable interstices in the formed cake, and to favorably impact the rheology of the fluids in those interstices, as the gases expand. The change in pressure within the chamber 40 is accomplished by programming or at least controlling the timing of valve openings to avoid having fluids flowing in an undesired direction from the chamber. In that regard, the opening of valve 56 and valve 62 functions to vent the chamber and permit the pressurized steam within the chamber to flash and evaporate and to carry liquids from the cake with the flashed gas and the reduction in pressure can cause the cake interstices to expand. That expanding of the interstices often and desirably forms a friable and fractured filter cake.

After the chamber pressure has been reduced, optionally, blowdown gas 54 or liquid clearing gas 50 can be entered into the chamber 40 through valve 56 to force the flashed liquid and gas from the chamber through the exit port 44.

When the pressure within the chamber has approached atmospheric or ambient pressure, the solids discharge 19 process is initiated and plate movement apparatus 46 can be actuated to open the chamber by separating plates 36 and 38. When the plates are fully separated, the filter medium movement apparatus 48 can be actuated to pass the filter medium out of the chamber 40 with the formed filter cake 43 on the medium for transport to a desired location (not shown). The filter medium is cleaned and transported to a position to reenter the filter chamber for the start of another batch operation of slurry separation. The controller 45 then determines whether the pressure filter chamber needs reheating for the next operation and the series of steps just described are initiated to process the next batch of slurry tor separation.

It has now been discovered that the process of bathing the cake with superheated steam and the later flashing of that steam by reducing the pressure within the chamber can materially reduce the liquid content of a discharged cake as well as often causing the cake to become more friable and shattered. Flashing causes the residual water in the cake to change phase from liquid to vapor and become steam and can move that changed phase cake water with the introduced steam as that steam is extracted from the chamber.

FIG. 2 illustrates a preferred method of operation of the present invention wherein the controller 43 initiates a cycle of the filter press. Initially the plates 36 and 38 are open with a filter medium 41 between the plates and positioned by monitoring detectable markings or the like on the belt medium as described in my U.S. Pat. No. 5,573,667. When the filter medium is properly positioned, a signal to the controller actuates the plate movement apparatus 46 to close the plates creating a filter chamber 40 by mating the plates 36 and 38 and their internal cavities 37 and 39 with the porous filter medium sealed within the filter chamber as described. The chamber is sealed by pressing the plates together with the filter medium between mating surfaces of the plates. The controller then initiates a preheating of the chamber 40 by introducing steam from the steam source 52. The controller then partially opens the bypass valve 62a and by suitable means monitors effluent exiting the chamber 40 and passing through the valve; (a) if the effluent is liquid from condensed steam indicating that the chamber has not become heated to the temperature of the steam, the heating of the chamber with steam should be, continued, or (b) it the effluent exiting the chamber is steam indicating that the chamber has been heated to the temperature of the steam, the heating of the chamber with steam can be discontinued. The desired temperature of heating for the chamber 40 is predetermined for the slurry being treated.

Controller then actuates the entry of slurry from source 43 through valve 60 and entry port 34. The controller 45 monitors slurry entry and distribution within the chamber 40 to control filling of the chamber. Valve 62 may be opened to accept liquids separated for the input slurry because of the differential in pressure of the input slurry and the pressure within the chamber. Optionally the controller can initiate a liquid clearing or cake forming gas entry into the chamber from source 50 (if needed or desired) to initiate the formation of a filter cake 47 within the chamber 40 on the filter medium 41. After initial cake formation has been completed as sensed within the chamber, the controller initiates the introduction of saturated steam from steam source 52 at high pressure and high temperature into the chamber to further force slurry liquids from the initially formed cake 47. The controller then may close, or partially close, valve 62 with valve 62a open, or partially open or choked or restricted, to pressurize the chamber 40 at the pressure of the steam and the high pressure and high temperature steam penetrates the pores of the cake 47 to move residual free liquid in the cake and to heat any interstitial liquids in the cake pores and to absorb those liquids into the penetrating steam. After the controller sense that the steam has penetrated the pores of the cake and/or a suitable time period has elapsed, valve 62 and 56 are opened in a programmed sequence of valve 56 first then valve 62 second thus reducing the pressure within the chamber 40. The reduction in pressure within the chamber 40 causes the steam within the chamber and within the formed cake to expand both the free steam and any steam in the pores of the cake. Desirably that expansion of the steam in the pores of the cake does two things; first, it releases any further liquids within the cake, combining those released liquids to join with any condensed liquid from the flashed steam to make the liquids mobile through the cake, and second, it causes the pores and interstices of the cake to expand often making the cake friable and fractured.

Optionally after the chamber has been vented, the controller can initiate the introduction of a blowdown gas from source 54 through valve 55 and valve 56 to force any further liquids out of the formed and expanded cake 47 through the port 44 and valve 62.

When the pressure control sensing elements determine that the pressure within the chamber 40 has attained atmospheric or ambient pressure, the controller actuates the plate movement apparatus 46 to separate the plates 36 and 38 to open the chamber 40. When the plates are fully open, the controller actuates the filter medium movement apparatus 48 and the belt 41 is moved out of the chamber 40 to a belt cleaning area and prepared for reentry into the chamber in preparation for the next batch cycle. The treated filter cake 47 is carried on the belt 41 (not shown) and discharged to a desired location as the belt is recycled.

In operation the apparatus shown in FIGS. 1, 2 and 3 can produce a filter cake having less that 10% moisture and, depending on the material of the slurry, can be as low as 1% moisture content.

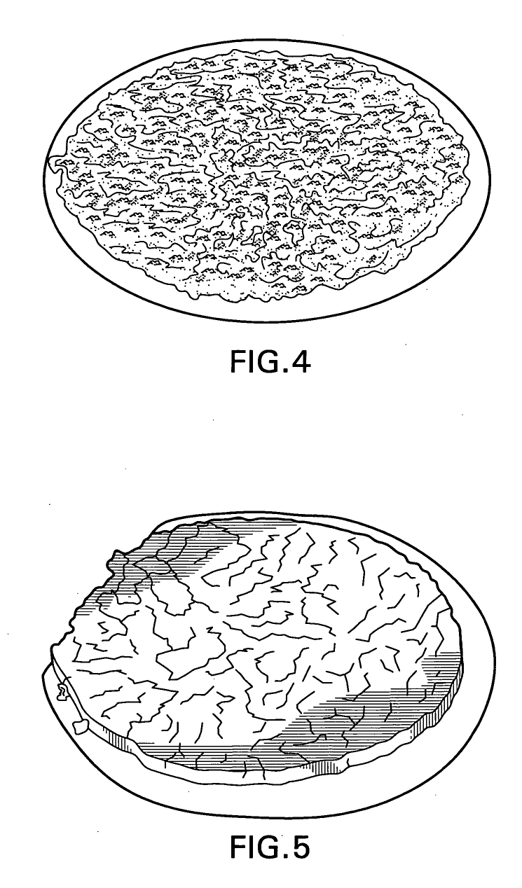

FIGS. 4 and 5 are photographs of actual filter cake produced in operation of a filter as illustrated in FIG. 3. FIG. 4 illustrates a cake formed from a slurry with the steps of preheating, slurry introduction, liquid clearing or cake forming with gas or steam and blowdown gas but without the step of penetrating the pores of a cake under the pressure of high temperature and high pressure steam and sudden release of pressure to cause flashing of the steam. FIG. 5 illustrates a cake formed from the same slurry and treated in accord with the present invention in the steps described above with steam bathing of the interstices of the cake with the steam penetration of the pores and interstices of the cake, followed by the flashing of the steam and expansion within the pores and interstices to cause the cake to further release liquids and to become fractured, friable and of lower moisture content.

The method and apparatus of the present invention is particularly useful in improving the overall efficiency of a slurry separation process because of the lowered moisture content and the friable structure of the resultant cake. Lower moisture content can eliminate the need for further drying and the friable mature of the cake can make further processing of the cake easier and more efficient.

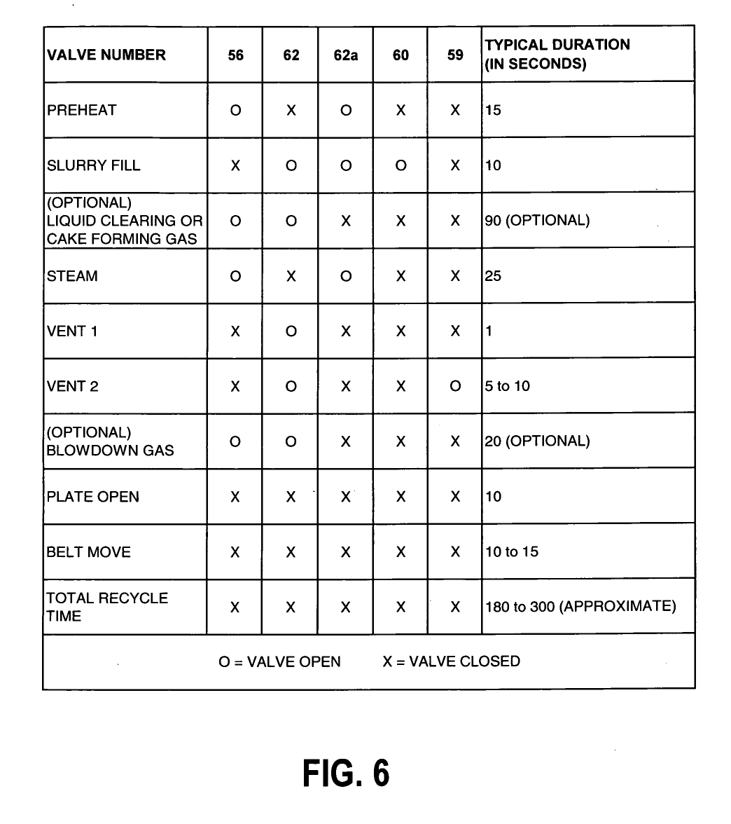

FIG. 6 illustrates the sequence of operations just described and shows the opening and closing of the respective valves. As shown in FIG. 6, the liquid cleaning and cake forming gas from the source 50 is optional in that the pressure of the introduced slurry can cause an initial removal of slurry liquids and can initiate the forming of a filter cake 47 of slurry solids. Also, the space above the introduced slurry within the chamber is hot due to the steam preheating and that elevated temperature can further create a differential of pressure to cause mobile liquid to separated from the slurry.

The use of blowdown gas from source 54 is also optional and used to force liquids that have been forced from the cake 47 by the penetration of the steam or flashed into mobile liquid and absorbed into the steam as it expands and condenses in the pores and interstices of the cake.

Sensing means for sensing sealing of the plates forming the filtration chamber, temperature and pressure within the chamber, effluent temperature and pressure, opening and closing of valves, filter medium position and other conditions communicated to the controller 45, while not specifically described herein, are devices well known in the automatic operation equipment arts.

The duration of introducing heating steam, slurry input, liquid clearing or cake forming gas, steam bathing, blowdown gas can be variable and independently controlled; some of which durations are time based, temperature based, weight based, pressure based, or volume based and can be predetermined and programmed with the controller or operator controlled. FIG. 6 illustrates possible time sequences for the several steps of the present invention and shows a possible total recycle time of about 180 to 300 seconds. As previously described, the filter apparatus operates in a batch mode so that one cycle when completed with a formed filter cake discharge from the chamber and the filter belt cleaned, the series of steps in the filtration operation are repeated with slurry input and separation to form a filter cake. Each cycle takes between 180 to 300 seconds depending upon the slurry being treated.

While certain preferred embodiments of the present invention have been specifically disclosed, it should be understood that the invention is not limited thereto as many variations will be readily apparent to those skilled in the art and the invention is to be given the broadest possible interpretation within the terms of the following claims.

I claim:

1. A pressure filter apparatus for separating a slurry into slurry liquid and slurry solids and for forming a substantially dry and often loosely packet filtered solids cake from said slurry, said filter apparatus comprising:
at least one pressure sealable filtration chamber, means for opening and closing said filtration chamber,
a filter medium, said medium being sealed within said filtration chamber when said chamber is closed and being movable through said chamber when said chamber is opened,
said means for opening and closing said filtration chamber to form said at least one sealed filtration chamber including means for positioning and sealing said filter medium within said filtration chamber when said chamber is closed and for controlling movement of said filter medium when said filtration chamber is opened,
a source of slurry coupled with said at least one filtration chamber,
at least one source of pressurizable fluid coupled with said at least one filtration chamber,
entry valving means connected to said filtration chamber for controlling entry of said slurry and said pressurizable fluid coupled with said at least one filtration chamber,
exit port means connected to said filtration chamber for controlling exit of fluids from said filtration-n chamber,
means for controlling said entry valving means for introducing said slurry into said filtration chamber and to uniformly distribute said slurry into said filtration chamber and for introducing said pressurizable fluid into said filtration chamber for separating slurry liquid from said slurry and to form said filtered solids cake on said filter medium,
means for controlling said exit port means for controlling fluid exit from said filtration chamber,
means for monitoring temperature and pressure conditions within said filtration chamber and for entry and exit of fluids into and from said filtration chamber,
said at least one source of pressurizable fluid including a steam generator for producing a steam fluid at a controlled temperature and controlled pressure,
means for introducing said steam fluid through said entry valving means into said filtration chamber to uniformly heat and pressurize said filtration chamber,
means for at least partially opening said exit port means and means for controlling and monitoring the temperature and pressure of fluids exiting from said filtration chamber at said exit port means to sense temperature of the interior of said filtration chamber,
means for at least partially closing said exit port means when a desired temperature and pressure has been reached within said filtration chamber,
means for opening said entry valving means to introduce slurry materials into said heated filtration chamber and, when said filtration chamber has been filled with slurry materials to a predetermined level, closing said entry valving means and partially opening said exit port means to initiate extraction of fluid from said slurry and to initiate the formation of said filtered solids cake within said filtration chamber and for withdrawing fluids from said slurry through said exit port means,
said means for closing said exit port means including means for opening said entry valving means for the entry of steam into said filtration chamber and for establishing a pressurized filtration chamber,
means for sensing when slurry liquids have been forced from said formed filtered solids cake, said means for sensing including means for introducing high temperature and high pressure steam into said filtration chamber to force said steam into the interstices of said formed filtered solids cake,
said means for sensing when said slurry liquids have been forced from said formed filtered solids cake including means for sensing when said high temperature and high pressure steam has penetrated said interstices of said formed filtered solids cake
said means for sensing further including means for closing said exit port means responsive to said means for sensing when slurry liquids have been forced from said formed filtered solids cake and said high temperature and high pressure steam has heated interstitial liquid in said interstices of said formed filtered solids cake and for pressurizing said filtration chamber,
said means for sensing including means for opening said entry valving means and said exit valving means to depressurize said filtration chamber and to cause said high temperature and high pressure steam and heated interstitial liquid in said interstices of said formed filtered solids cake to flash and partially condense and to absorb substantially all of fluids remaining in said formed filtered solids cake into said hot steam and to cause said filtered solids cake to become substantially dry and often loosely packed and for discharging said heated interstitial liquid condensed and absorbed fluids from said depressurized filtration chamber through said exit port,
said means for sensing further including means for sensing when the pressure within said filtration chamber has dropped to approximately ambient pressure and for actuating said means for opening said filtration chamber,
and means for sensing when said filter chamber is open for activating said means for moving said filter medium from within said filtration chamber and for carrying said formed substantially dry and often loosely packed filtered solids cake out of said filtration chamber.

2. The apparatus of claim 1 wherein said at least one pressure sealable filtration chamber is a plurality of duplicate aligned filtration chambers, each chamber made up of aligned upper and lower plates mating to form individual filtration chambers with said filter medium positioned to be movable through each filtration chamber.

3. The apparatus of claim 2 wherein said means for sensing includes,
a) means for sensing when said filtration chamber is closed by sensing a pressure at mating surfaces closing said filtration chamber,
b) means for opening said entry valving means to introduction of said steam to uniformly heat and pressurize said filtration chamber,
c) means for restricting said exit port means to restrict exit of fluid from said filtration chamber,
d) and means for controlling entry of steam and exit of fluid based on time, or sensed temperature, or pressure, or a combination of time, temperature, or pressure within said filtration chamber.

4. The sensing apparatus of claim 3 including
a) means for restricting or closing said exit port means and opening said entry valving means,
b) means for connecting said source of slurry to said entry valving means to introduce said slurry into said heated filtration chamber,
c) and means for controlling the passage of slurry through said entry valving means based on time, or flow of slurry, or slurry weight, or slurry pressure within said filtration chamber.

5. The apparatus of claim 1 wherein said at least one source of pressurized fluid includes a steam generator for generating steam at a pressure and temperature that is at least equal to the pressure and temperature in said pressurized filtration chamber after said chamber is heated and said slurry has been introduced into said filtration chamber, whereby said steam penetrates into interstices in said initially formed filtered solids cake.

6. The apparatus of claim 5 wherein said sensing means includes:
a) means for sensing when said steam has penetrated into said interstices of said initially formed filtered solids cake,
b) means based on time or filtered solids cake composition for opening said entry valving means and said exit port means to release pressure in said filtration chamber,
c) means based on time or pressure after said pressure release in said filtration chamber for connecting a source of air to said input valving means to pass said air through said filtered solids cake.

7. The apparatus of claim 1 wherein said sensing means includes:
a) means based on time, temperature, or pressure within said filtration chamber for actuating said means for moving said filter medium to transport said formed substantially dry and often loosely packed filtered solids cake out of said filtration chamber.

8. In a combination comprising a pressure filter apparatus, a steam generator for generating steam at controlled temperature and pressure, and programmable control means for controlling operation of said filter apparatus and said steam generator, said pressure filter apparatus having at least one pressurizable filter chamber for receiving a slurry of liquids and solids for forming a filtered solids cake in a substantially dry and often loosely packed form, entry valving means for introducing said slurry and said generated steam into said pressurizable filtration chamber for separating liquids from solids in said slurry and an exit port means for separated liquids, said combination comprising;
a) means for introducing slurry into said pressurizable filter chamber through said entry valving means and for initially extracting a portion of liquids from said slurry through said exit port means and initially forming a filtered solids cake,
b) means for introducing pressurized steam in a vapor state through said entry valving means into said pressurized filter chamber after said initially formed filter solids cake has been formed and for passing said vapor state steam into the interstices within said initially formed filter solids cake while maintaining pressure within said filter chamber,
c) means for sensing when said vapor state steam has penetrated into said interstices of said initially formed filtered solids cake,
d) means based on time or filtered solids cake composition for opening said entry valving means and said exit port means in a preprogrammed sequence to release pressure in said filtration chamber
(e) said preprogrammed sequence of valve and port opening means for releasing the pressure within said pressurized filter chamber after said pressurized vapor state steam has penetrated said interstices of said initially formed filter solids cake to permit said penetrated vapor state steam to flash below its vapor state and expand while absorbing residual fluids in said interstices of said initially formed filter solids cake and to cause said cake to expand and to be substantially dry and loosely packed,
f) means based on time or pressure after said pressure release in said filtration chamber for connecting a source of air to said input valving means to pass said air through said filtered solids cake,
g) and means for removing said substantially dry and loosely packed filtered solids cake from said filter chamber.

9. The apparatus of claim 1 including a programmed controller for controlling said entry valving means, exit port means, said opening and closing of said filtration chamber and movement of said filter medium in response to sensed conditions of temperature, pressure, height, weight or time at said filtration chamber.

10. A method to form a substantially dry and often loosely packet filter solids cake from an initially formed filter cake in a pressure filter apparatus comprising:
a) introducing a high temperature and high pressure vapor phase steam into the pressure filter apparatus to force the vapor phase steam into the interstices of the formed filter cake;
b) reducing the pressure within the filter apparatus to permit the vapor phase steam to flash and to expand within the interstices to absorb any remaining fluids within the formed filter cake and to thereby cause the filter cake to become substantially dry and loosely packed; and
(c) discharging the substantially dry and loosely packed filter solids cake from the filer apparatus,

11. A method for increasing filtered solids content often resulting in looseness and friability of an expanded filtered solids filter cake formed in a pressure filter apparatus wherein a slurry of liquids and solids is introduced into a pressurizable filter chamber within said filter apparatus and a filter cake is formed from slurry solids retained on a filter medium within said pressurizable filter chamber by initially separating at least a part of slurry liquids from slurry solids and initially forming a slurry solids filter cake on said filter medium comprising the steps of:
a) maintaining an elevated temperature and pressure within said pressurizable filter chamber with said initially formed filter cake in place,
b) introducing high temperature and high pressure vapor phase steam into said elevated pressure filter chamber, said vapor phase steam being at a temperature and pressure to remain in a vapor phase within said filter chamber, and causing said vapor phase steam to permeate the pores of said initially formed filter cake to absorb residual liquid or moisture from said initially formed filter cake, and
c) then after said vapor phase steam has permeated said pores of said initially formed filter cake, reducing the pressure within said filter chamber to cause said high temperature and pressure vapor phase steam permeated into said initially formed filter cake to flash and expand within said initially formed filter cake to cause residual liquid or moisture within said filter cake to change phase or expand and form said filter cake into a substantially loose and friability expanded filtered slurry solids filter cake,
d) and extracting said flashed residual liquid and moisture including any excess slurry and filter cake fluids from said expanded filter cake.

12. The method of claim 11 with the additional steps of:
a) preceding the introduction of slurry into said filter chamber with the introduction of steam into said filter chamber to preheat and pressurize said filter chamber,
b) after introducing said slurry into said heated filter chamber, passing gasses and/or liquids through said introduced slurry to extract liquids from said slurry at an exit port and to initially form said slurry solids filter cake on said filter medium,
c) discontinuing said passing of gasses and/or liquids through said initially formed slurry solids filter cake while maintaining said exit port at least partially open,
d) introducing high temperature and pressure vapor phase steam into said heated filtration chamber and at least partially closing said exit port to pressurize said filtration chamber,
e) forcing residual interstitial liquids from said filter cake by causing said high temperature and pressure vapor phase steam to permeate interstices of said initially formed slurry solids filter cake,
f) discontinuing the introduction of high temperature and pressure vapor phase steam and then reducing the pressure within said filter chamber by venting or reducing chamber pressure to cause said vapor phase steam and interstitial liquids within said filter cake to change phase to expand to flash and reduce interstitial fluids within said interstices of said initially formed filter cake and to often cause said slurry solids filter cake to become loose and friable, and
g) withdrawing said filter medium with said formed loose and friable substantially dry slurry solids filter cake from said filter chamber.

13. The method of claim 12 wherein said temperature of preheating said filter chamber is sensed at said exit port by determining whether hot water or steam is exiting from said chamber at said exit port means.

14. The method of claim 12 wherein the introduction of slurry is discontinued and said exit port is at least partially open to permit liquids to be extracted from said slurry within said preheated filter chamber, and said exit port is controlled during said introduction of said high pressure vapor phase steam.

15. The method of claim 12 wherein said gasses and/or liquids passed through said slurry includes hot wash fluid and after initially forming said filter cake includes hot air to extract fluids from said initially formed filter cake.

16. The method of claim 11 including the additional step of introducing hot air into said filter chamber after reducing the pressure within said filter chamber to extract any remaining fluids from said expanded filter cake.
